(19) United States
(12) Patent Application Publication
(10) Pub. No.: US 2004/0231403 A1
(43) Pub. Date: Nov. 25, 2004

(54) Mechanic's air meter

(76) Inventor: Preston Danal Johnson, Palm Desert, CA (US)

Correspondence Address: Preston Danal Johnson, 73 418 Pinyon St., Palm Desert, CA, 92260, US

(21) Appl. No.: 10/441,227

(22) Filed: May 20, 2003

(51) Int. Cl. G01M 15/00

(52) U.S. Cl. 73/115

(57) ABSTRACT

The “Mechanic's Air Meter” Is an all new differential compression tester body to accommodate the new air control valve, and other (old) required appurtenances as is normally found in existing differential compression testers. The primary objective is for a safer way to conduct the differential compression test on piston driven engines.

The Federal Aviation Administration (FAA) requires a differential cylinder compression test be conducted on all piston engined Civil Registered Airplanes used for compensation or hire.

This test must be accomplished every 100 hours of operation, or at the least, on all piston engine airplanes during every Annual Inspection.

On aircraft engines, this test is conducted by the mechanic setting the piston on top dead center of the cylinder, and holding the propeller to prevent uncontrolled and violent propeller movement while the differential compression tester is introducing 80 PSI air pressure into the cylinder. The test is also used to trouble shoot engine problems between inspections.

The FAA Regulations mandates the amount of pressure to be used during the differential compression test, and also the design of the orifice, (6) the size of the orifice, and the air approach ramp angle.

Primary use of the differential compression testing, is to help determine the condition of individual cylinders of internal combustion engines. (old)

As an Aircraft Mechanic, I realized a safer way was needed to conduct this all important test. I saw serious injuries and close calls, of both the conductors of the tests and bystanders.

As all Aircraft Mechanics know, the compression test is a very dangerous undertaking. The normal routine requires the Mechanic to hold and rock the propeller with one hand, with the piston near the top of it's travel, while 80 PSI air is fed into the cylinder through the spark plug hole, with the aid of a compression tester.

This invention allows a greater margin of safety to all concerned, inasmuch as the operator has easier, and more positive control of the air while pressurizing, and un-pressurizing the cylinder.

With the cylinder under pressure, the operator, holding the “Mechanics Air Meter” in hand, can instantly depress the valve with one finger, thereby immediately bleeding off the air pressure.

In the past, differential compression testing, generally required the operator to use one hand to hold/rock the propeller, and the other to operate a tester, and in an emergency, let go of something to disconnect the hose, or stand back and let the propeller spin, in order to release the air pressure between the compression tester and the engine cylinder.

I first invented this compression tester, Mar. 8, 1999, and my son and I have been discreetly using two prototypes continuously since then. And they have performed flawlessly, requiring no maintenance.

### SPECIFICATIONS

This devise, “Mechanic's Air Meter” enables this undertaking to be much less dangerous, through it's ability to release the required air pressure in the cylinder quickly and easily.

While holding/rocking the propeller with one hand, the operator can slowly or quickly pressurize, or release the air pressure with the other hand without changing his/her grip on the propeller, or the Mechanic's Air Meter, or having the need of yet another hand to disconnect a hose, or turn a valve etc.

By the design of the air control/release valve, should an internal seal malfunction, a significant amount of air pressure will not enter the engine cylinder.

The devise may also be used on most other types of internal combustion engine, to test the compression leakage of that engine. In the absence of a propeller, the crankshaft would need to be turned, or held by other means.

The “Adapter” (old) is only different from the view that the knurling lends itself to screwing into the spark plug hole by hand, screw into the body (1), for storage, and to direct air through the small hole (4) for a gage calibration check. The check is accomplished by the known expected gage reading.

The body, and the component parts of the device is either cast, forged, and/or machined from a suitable metal or plastic, to facilitate a convenient one handed operation of the device.

The accessory, gages, fittings, air regulators, hoses, etc. are of generic nature.

### DRAWINGS

The drawings show the principals, and works of the “Mechanics Air Meter”, as well as parts identification.

The “Mechanic's Air Meter” is shown without the generic regulator, gages, hose, and air hose fittings for clarity.

FIG. 1, is an edge view of the main body (1) of the Mechanic's Air Meter, the line “I” shows a cut-away section for FIG. 2.

FIG. 2, shows the cut-away view “I”, to expose the internal workings of the devise.

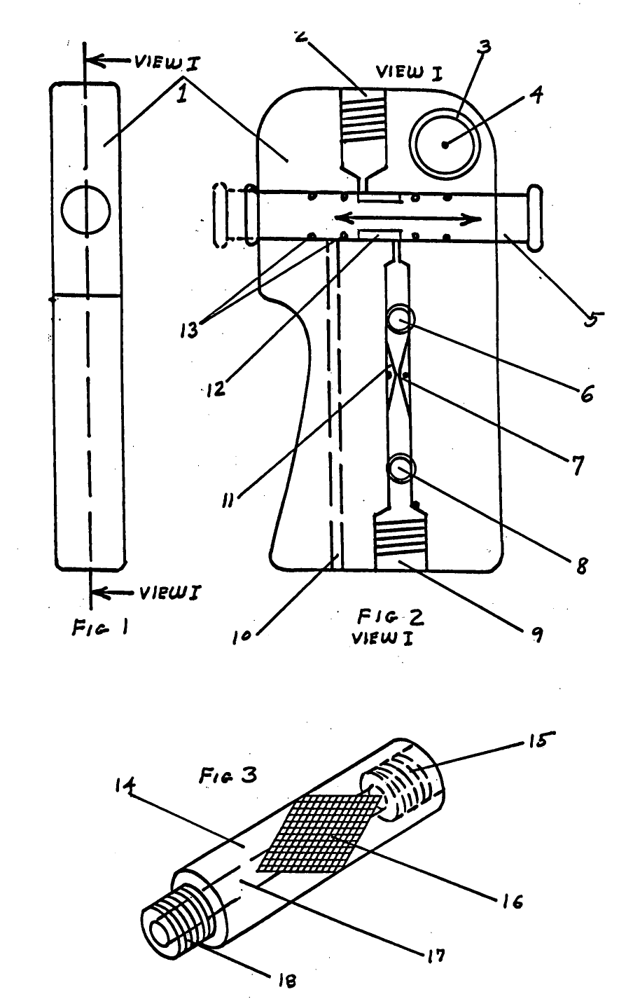

### SIGNIFICANT PARTS OF THE “MECHANIC'S AIR METER”

1 The body, fabricated of metal or plastic.

2 The pressure air outlet to the engine cylinder, by way of an air fitting, hose and adapter.

3 Threaded receiver for storage of the spark plug adapter.

4 Fixed air passage hole to check relevant air pressure gage indications.

5 Air pressure feed into cylinder, and quick air release valve, actuated in a convenient manner by thumb and/or forefinger etc.

6 Threaded air passage hole for secondary air pressure gage sampling.

7 Seal. (old)

8 Threaded air inlet passage for primary (First) air pressure gage sampling.

9 Regulated air pressure inlet hole, an air pressure regulator (old) may be screwed directly into this inlet. (FAA mandated, regulated 80 psi.)

10 Quick, engine cylinder pressure release valve, air exit.

11 The FAA designed orifice, with ramp. (old)

12 Pressure air transfer chamber, directs pressure air to the engine cylinder, and also quickly directs air out of the cylinder in an emergency situation by one hand actuation of the quick air release valve.

13 Seals. (old)

FIG. 3 Spark Plug adapter. (old)

14 Spark plug adapter, fabricated from plastic or metal. (old)

15 Threads to accept generic hose fitting. (old)

16 Knurling or flutes, for installing the AIR METER hose adapter by hand.

17 Air passage galley. (old)

18 Threaded end for insertion into cylinder spark plug hole. (old)

What I claim as my invention is:

Independent Claim

1. An improvement over all other compression testers, (old) by it being an easy one handed air control operation, with a provision to quickly release air pressure in an emergency, and otherwise, during a cylinder differential test.

Dependent Claim
the design of the air control valve (5) in such a way that an internal seal failure presents no great hazard, by introducing an unexpected regulated or higher air pressure into the cylinder:

Dependent Claim
The adapter receiver/holder (3), as an integral part of the body (1), that with a small hole (4), also allows a quick gage calibration check for the “Mechanic's Air Meter”.

Dependent Claim
An improvement to the spark plug adapter (old) by knurling which eliminates the need of a tool to assure a sufficient no leak fit at the engine cylinder and in the “Mechanic's Air Meter” body.
